(19) United States
(12) Patent Application Publication
(10) Pub. No.: US 2012/0266718 A1
(43) Pub. Date: Oct. 25, 2012

(54) BICYCLE PEDAL ASSEMBLY

(76) Inventor: TA-CHING YANG, New Taipei City (TW)

(21) Appl. No.: 13/090,275

(22) Filed: Apr. 20, 2011

(51) Int. Cl. B62M 3/08

(52) U.S. Cl. 74/594.6

(57) ABSTRACT

A bicycle pedal assembly includes a pedal forming in a central portion thereof a hollow portion; an axle unit movably received in the hollow portion and including a central axle and self-lubricating bearings fit to the central axle and respectively located at opposite ends of the hollow portion; and an abrasion resistant unit mounted to an end of the central axle. As such, the axle unit is coupled to a bicycle, so that when a rider applies a force to the pedal for pedaling operation, the abrasion resistant unit helps protecting the pedal from abrasion and wear induced by direct contact and thereby extends the life space.

### (a) TECHNICAL FIELD OF THE INVENTION

The present invention generally relates to an improved structure of bicycle pedal, and more particularly to a bicycle pedal assembly that comprises an axle unit coupleable to a bicycle in such a way that when a rider applies a force to the pedal for pedaling operation, an abrasion resistant unit helps protecting the pedal from abrasion and wear induced by direct contact and thereby extending the service life.

### (b) DESCRIPTION OF THE PRIOR ART

A conventional bicycle pedal assembly (see FIG. 5) comprises a pedal 4, a central axle 5 movably coupled with the pedal 4, self-lubricating bearings (not shown in the drawing) respectively fit to opposite ends of the central axle 5, a locking nut 6 mounted to an end of the central axle 5, and at least two washers 61 arranged between the locking nut 6 and the pedal 4. With such an arrangement, an opposite end of the central axle 5 is coupleable to a bicycle to allow the pedal 4 to receive a force from a rider for moving the bicycle.

When the rider takes a pedaling operation by applying a force to the pedal 4, the pedal 4 is caused to rotate on the central axle 5, and abrasion is induced between the two washers 61 that engage each other. A long term use of this way would cause severe wear of the washers 61, making the rotation of the pedal 4 about the central axle 5 unstable and thereby significantly shortening the service lives of the pedal 4 and the central axle 5.

### SUMMARY OF THE INVENTION

A primary objective of the present invention is to overcome the above discussed drawbacks and to couple an axle unit to a bicycle in such a way that when a rider applies a force to the pedal for pedaling operation, an abrasion resistant unit is provided for protecting the pedal from abrasion and wear induced by direct contact and thereby extending the service life.

To achieve the above objective, the present invention provides an improved structure of bicycle pedal assembly, which comprises a pedal that forms in a central portion thereof a hollow portion; an axle unit that is movably received in the hollow portion and comprises a central axle and self-lubricating bearings fit to the central axle and respectively located at opposite ends of the hollow portion; and an abrasion resistant unit that is mounted to an end of the central axle.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is an exploded view of a thrust bearing according to the present invention.

FIG. 4 is a cross-sectional view of the present invention taken along line A-A of FIG. 1.

FIG. 5 is a perspective view of a conventional bicycle pedal.

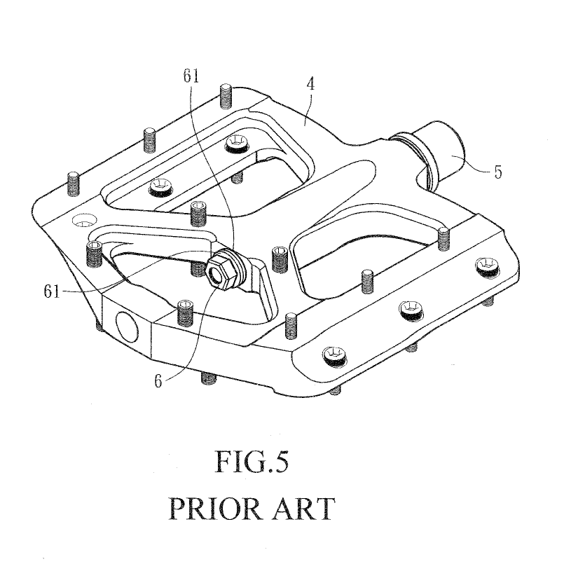

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

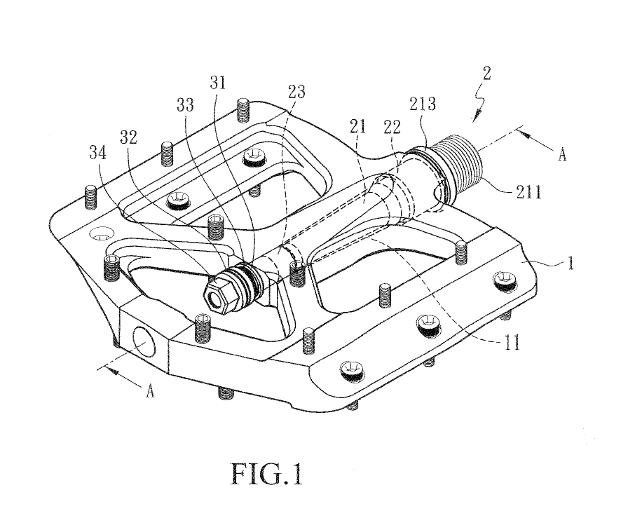

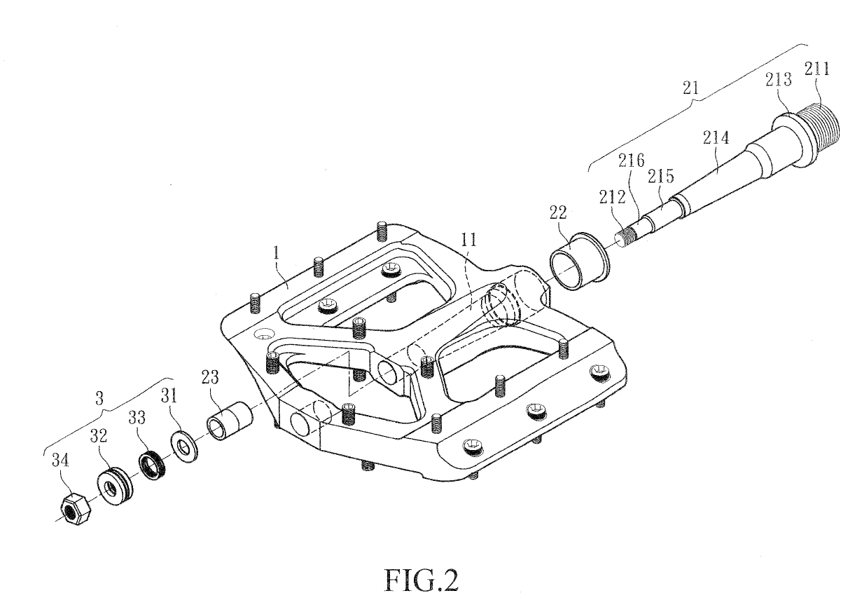

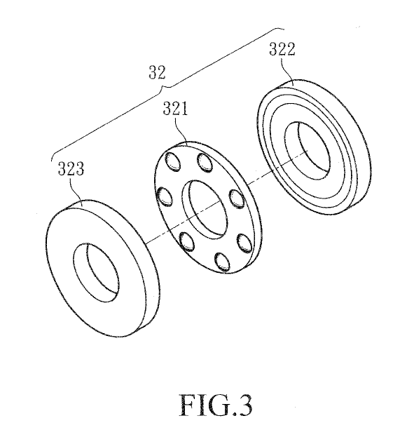

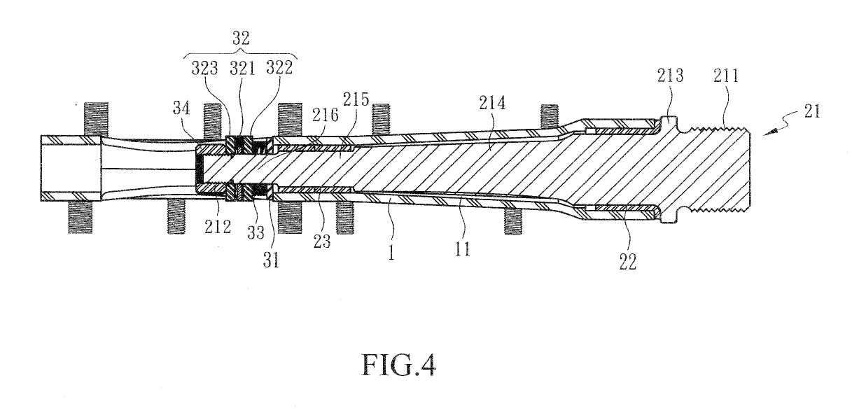

Referring to FIGS. 1, 2, 3, and 4, which are respectively a perspective view of the present invention, an exploded view of the present invention, an exploded view of a thrust bearing used in the present invention, and a cross-sectional view of the present invention taken along line A-A of FIG. 1, these drawings show that the present invention relates to an improved structure of a bicycle pedal assembly, which comprises at least a pedal 1, an axle unit 2, and an abrasion resistant unit 3.

The pedal 1 forms a hollow portion 11 in a central portion thereof. The pedal 1 can be made of a material including metal, rubber, or a composite material comprising metal wrapped by rubber.

The axle unit 2 is movably received in the hollow portion 11 and comprises a central axle 21 and self-lubricating bearings 22, 23, which are fit over the central axle 21 and are respectively positioned at opposite ends of the hollow portion 11. The central axle 21 has two ends respectively forming first and second threading sections 211, 212 that respectively extend outside the two ends of the hollow portion 11. The first threading section 211 forms, at one end thereof, a positioning rim 213. First, second, and third axle segments 214, 215, 216 are sequentially and successively formed between the positioning rim 213 and the second threading section 212 with the self-lubricating bearings 22, 23 respectively fit to a location of the first axle segment 214 adjacent to the positioning rim 213 and the second axle segment 215.

The abrasion resistant unit 3 is arranged at one end of the central axle 21. The abrasion resistant unit 3 comprises at least one washer 31, a thrust bearing 32 positioned on a surface of the washer 31, an elastic member 33 arranged between the washer 31 and the thrust bearing 32, and a locking nut 34 set at one side of the thrust bearing 32 and mounted through threading engagement to the second threading section 212. The washer 31, the thrust bearing 32, and the elastic member 33 are all fit to the third axle segment 216. The thrust bearing 32 comprises a ball retainer plate 321 and a first runner board 322 and a second runner board 323, which are respectively positioned on opposite sides of the ball retainer plate 321. The elastic member 33 is arranged between and in engagement with the first runner board 322 and the washer 31. The second runner board 323 is positioned against the locking nut 34. As such, the above components are properly assembled to provide a novel improved structure of bicycle pedal assembly.

To use the present invention, the first threading section 211 of the axle unit 2 is set in coupling with a bicycle (not shown) to allow the pedal 1 to serve as a device that a rider may pedal to move the bicycle. When the riders applies a force to the pedal 1 by taking a pedaling operation, the pedal 1 is caused to rotate about the axle unit 2, where the central axle 21 takes advantage of the arrangement of the self-lubricating bearings 22, 23 to provide the pedal 1 with smooth rotation. Further, during the rotation of the pedal 1, the washer 31, the thrust bearing 32, the elastic member 33, and the locking nut 34 collectively maintain the first runner board 322 in a substantially fixed condition, while allowing the ball retainer plate 321 and the second runner board 323 to rotate together. This allows the thrust bearing 32 of the abrasion resistant unit 3 to protect the pedal 1 from direct physical engagement and inducing abrasion.

In summary, the bicycle pedal assembly according to the present invention can effectively overcome the drawbacks of the conventional devices and couples the axle unit to a bicycle, so that when a rider applies a force to the pedal to do pedaling, the abrasion resistant unit helps preventing the pedal from physical contact that induces abrasion, thereby providing effective protection against abrasion and wear and extending service life.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A bicycle pedal assembly, comprising:
a pedal, which forms a hollow portion in a central portion thereof;
an axle unit, which is movably received in the hollow portion and comprises a central axle and self-lubricating bearings that are fit to the central axle and arranged at opposite ends of the hollow portion; and
an abrasion resistant unit, which is arranged at one end of the central axle.

2. The bicycle pedal assembly according to claim 1, wherein the pedal is made of a metal material.

3. The bicycle pedal assembly according to claim 1, wherein the pedal is made of rubber.

4. The bicycle pedal assembly according to claim 1, wherein the pedal is made of a composite material comprising a metal material wrapped by rubber.

5. The bicycle pedal assembly according to claim 1, wherein the central axle has two ends respectively forming first and second threading sections extending outside two ends of the hollow portion, the first threading section forming a positioning rim at one end thereof, first, second, and third axle segments being sequentially and successively formed between the positioning rim and the second threading section, the self-lubricating bearings being respectively fit to a location of the first axle segment adjacent to the positioning rim and the second axle segment, the abrasion resistant unit being arranged on the second threading section and the third axle segment.

6. The bicycle pedal assembly according to claim 1, wherein the abrasion resistant unit comprises at least one washer, a thrust bearing positioned on a surface of the washer, an elastic member arranged between the washer and the thrust bearing, and a locking nut set at one side of the thrust bearing and mounted to the central axle.

7. The bicycle pedal assembly according to claim 6, wherein the thrust bearing comprises a ball retainer plate and a first runner board and a second runner board, which are respectively positioned on opposite sides of the ball retainer plate, the elastic member being arrangement between and in engagement with the first runner board and the washer, the second runner board being positioned against the locking nut.
